(19) United States
(12) Patent Application Publication
(10) Pub. No.: US 2024/0024948 A1
(43) Pub. Date: Jan. 25, 2024

(54) FEEDING DEVICE FOR SEALER

(71) Applicant: FERRUM PACKAGING AG, Schafisheim (CH)

(72) Inventor: Thomas MÜLLER, Safenwil (CH)

(21) Appl. No.: 18/219,063

(22) Filed: Jul. 6, 2023

(30) Foreign Application Priority Data
Jul. 19, 2022 (EP) 22185610.7

(51) Int. Cl. B21D 51/32

(52) U.S. Cl. CPC B21D 51/32

(57) ABSTRACT

A feeding device for a sealer for guiding a lid to a container includes a movement device arranged such that the lid is able to be moved by the movement device, and a lid guide arranged at the movement device for guiding the lid to the container. The lid guide includes a first guide surface and a second guide surface, and the lid can be arranged between the first guide surface and the second guide surface such that the lid is capable of being guided to the container by relative movement of the movement device to the first and second guide surfaces.

### CROSS-REFERENCE TO RELATED APPLICATION

This application claims priority to European Patent Application No. 22185610.7, filed Jul. 19, 2022, the contents of which are hereby incorporated by reference in its entirety.

### BACKGROUND

### Technical Field

The disclosure relates to a feeding device for a sealer and a sealer for sealing a container. The disclosure further relates to a method for sealing a container by a feeding device according to the disclosure and a sealer according to the disclosure.

### Background Information

During the filling of beverage cans or food cans, the cans pass through a can sealer after being filled with the beverage or foodstuff, whereby the filled can bodies enter via a feed path and can lids enter via a further feed path. The can sealer usually has several similar stations arranged in a carousel shape, in each of which a can is sealed with a can lid. The can lids are guided onto the can bodies and held on the can body by a holding plate of a seaming head. This holding also serves to fix the cans against breaking out of the circular path passed by the cans in the can sealer due to the centrifugal force. In the can sealer, the can bodies with the can lids are seamed over a seaming roller at the edges and thus sealed. Normally, the can with the can lid is additionally rotated around its own axis of symmetry by the seaming head. For rotation, the seaming rollers and seaming heads are arranged on a respective seaming shaft.

A generic can sealer is described in DE 749636 and DE 4234115 A1. The can sealer comprises a clamping device for receiving a can to be sealed. In the operating state, the can to be sealed is introduced into the clamping device and secured by the clamping device in the axial and radial directions. A can lid is also introduced centered over the can opening of the can to be sealed. The can has a circumferential can flange in the area of the can opening and the can lid has a circumferential can lid flange. For sealing the can opening with the can lid. the can sealer additionally comprises two seaming rollers, mounted rotatably about an axis in each case, which seaming rollers press the can flange and the can lid flange together by a force acting substantially radially, the pressing being effected by a continuous rolling in the circumferential direction along the circumference of the can opening.

A further can sealer is known from GB 2098899 A. The can sealer comprises a clamping device for receiving the can to be sealed and a seaming roller. In the operating state, the can to be sealed is introduced into the clamping device and secured by the clamping device in the axial and radial directions. A can lid is also introduced centered above the can opening of the can to be sealed. The can bas a circumferential can flange in the area of the can opening of the can body and the can lid has a circumferential can lid flange.

For a better understanding of the subject matter of the present disclosure, a conventional can sealer with feeding device known from the state of the art is described in the following on the basis of FIGS. 1 and 2.

For a better distinction of the known state of the art from the present disclosure, reference signs to features of known devices are provided with an inverted comma (in FIGS. 1 and 2) in the context of this application, whereas features to devices according to the disclosure or their components do not carry an inverted comma.

The can sealer 1000′ according to FIG. 1 comprises a lid providing device 11′ for providing a lid 101′, a gassing rotor 10′ for supplying gas to the can 100′ and for guiding and transporting the lid 101′ to the can 100′. In addition, the sealer comprises a seaming process/carousel with seaming stations 14′ for sealing the can 100′ with the lid 101′. Thereby, the seaming process 14′ is arranged in a working space 2′ of the can sealer 1000′ surrounded by a housing 3′.

The lid 101′ is introduced by the lid providing device 11′ into the working space 2′ of the can sealer 1000′ along the arrow C′. In this process, the lids 101′ are placed on the gassing rotor 10′. By rotation of the gassing rotor 10′, the lids 101 are transported further. Then, the cans 100′ are introduced in direction A′ by the container feeder 12′ into the container receptacles 17′ of the gassing rotor 10′. There, the can is gassed in area D′ with a gas such as carbon dioxide or nitrogen and is united with the lid 101′.

The gassing is carried out along the arrow B′ by the gas supply 16′ via the gassing rotor 10′. After gassing, the container 100′ with the lid 101′ is guided further by the container transfer 13′ from the gassing rotor 10′ to the seaming process 14′ and is sealed there.

The cans 100′ are clamped with the lid 101′ and sealed by the seaming process 14′. The sealed can is conveyed by a further rotor into the can outlet 18′.

During gassing by the gassing rotor 10′, the gas is conveyed to an underside of the lid 101′. In this way, it can be ensured that a residual volume of the can 100′ in which no foodstuff is arranged is substantially filled with the gas before sealing, wherein the air originally present in the residual volume is displaced as completely as possible by the gas. In this way, if necessary, a longer shelf life of the foodstuff arranged in the can 100′ can be achieved.

### SUMMARY

As can be understood, the lid 101′ is always placed on the gassing rotor 10′ and is only supported by a stationary rail 15′. However, it has been determined that the gassing rotor 10′ has interfering contours which complicate an efficient gassing of the can 100′ when it is united with the lid 101′. In addition, the possible variety of can shapes is limited by the shape of the recesses 17′ and the shape of the lid receptacles 20′ with lid carriers 19′.

For this reason, tool changes to adapt to other can formats cannot be avoided. Thereby, the current tool change times are very high.

In addition, the lids 101′ are held in the rail 15′ in radially milled grooves. Due to this, cleaning is much more difficult, as it is very difficult for the cleaning medium to penetrate the grooves.

It is therefore an object of the disclosure to provide a feeding device and a sealer, which avoid the adverse effects known from the state of the art. In particular, a feeding device and a sealer are to be provided which are simply designed, versatile, quickly adaptable, and easy to clean.

The object is met by a feeding device according to the disclosure, a sealer according to the disclosure and by the method according to the disclosure.

According to the disclosure, a feeding device for a sealer for guiding a lid to a container is proposed. Here, the feeding device comprises a movement device, which is arranged in a moveable manner in such a way that the lid can be moved by the movement device, and a lid guide arranged at the movement device for guiding the lid to the container. The lid guide has a first guide surface and a second guide surface, wherein the lid can be arranged between the first guide surface and the second guide surface in such a way that the lid can be guided to the container by relative movement of the lid movement device to the first guide surface and the second guide surface.

Thus, the lid can be set in motion by the movement device, but the direction of the lid movement is predetermined by the lid guide, i.e., the first and the second guide surface. The lid is preferably supported on the lid guide/is carried by the lid guide and is not placed on the movement device as in the state of the art (i.e., is not carried by the movement device). The lid can thus be supported on the lid guide in such a way that the lid is carried by the lid guide.

The relative movement of the movement device to the first guide surface and the second guide surface can be understood to mean, in particular, that the first guide surface and the second guide surface are stationarily arranged (i.e., immovable), wherein the movement device moves past the first guide surface and the second guide surface and moves the lid between the guide surfaces in this way. Preferably, the movement device can be moved along the first guide surface and the second guide surface, in particular can be moved between the first guide surface and the second guide surface, so that the lid can be moved between the guide surfaces.

The lid guide can comprise a support surface for carrying/supporting the lid, preferably a first and second support surface, on which the lid can be arranged and on/via which the lid can be moved by the movement device. Thus, the lid could be moved along the first and second guide surface and on the (first and second) support surface. However, inclined guide surfaces (having an angle not equal to 90° compared to a lid surface) can also function as support surfaces, so that the lid can be arranged on the inclined guide surfaces.

Particularly preferably, the lid is carried exclusively by the support surface/support surfaces or the inclined guide surfaces and is not placed on the movement device.

Thus, a simpler and more stable lid guide is provided in particular by the feeding device according to the disclosure. In particular, the lid no longer has to be placed on a gassing rotor but can rest on the lid guide until it is brought together with the container. Since the lid no longer rests on the gassing rotor, a greater variety of can shapes (particularly in relation to a neck area of the container) can be sealed.

To enable a simple and rapid adaptation to different lid formats and shapes, the first and second guide surface can be displaceably arranged relative to each other in such a way that a distance between the first and second guide surface can be changed. In this way, the changeover time for machine parts in the sealer can be significantly reduced.

In an embodiment of the disclosure, the lid guide can be stationarily arranged in the feeding device in such a way that the lid can be guided to the container by the movement of the movement device along the lid guide.

In addition, the movement device can comprise a carrier. Preferably, the carrier is attached to the movement device in such a way that the lid can be received by the carrier and can be moved in the lid guide by the carrier. Thus, the carrier is that part of the movement device by which the lid is contacted and moved.

In this context, can be moved in the lid guide means, in particular, that the carrier can move the lid along the guide surfaces and via the guide surfaces or support surfaces. For this purpose, the carrier can be arranged in a moveable manner between the first guide surface and the second guide surface (possibly also between the first and second support surface).

In practice, the movement device can comprise a plurality of carriers so that a plurality of the lids can be received by the plurality of the carriers and can be moved by the lid guide. Preferably, the plurality of carriers can be distributed along a circumference of the movement device. Here, the plurality of the carriers can be arranged circularly along the circumference of the movement device. Particularly preferably, the movement device is attached to a shaft and arranged in a rotatable manner about an axis by this shaft, so that the lid can be moved by a rotation of the movement device. The movement device can therefore be a rotatable movement device For this purpose, the movement device is preferably designed in the shape of a disk, or a circular ring and the shaft is arranged at a center point of the movement device.

Carriers arranged at the movement device can be arranged on a surface of the movement device (i.e., in particular, the disk/circular ring) in such a way that they extend in the direction of the axis about which the shaft rotates, or can be arranged on a surface of the movement device (i.e., in particular, the disk/circular ring) that extends perpendicular to the axis about which the shaft rotates.

As an alternative to the rotatable movement device, a linearly movable movement device can also be used.

Particularly preferably, the lid guide comprises a first rail and a second rail arranged along the first rail, in particular a second rail running parallel to the first rail. The first rail comprises the first guide surface and the second rail comprises the second guide surface in such a way that the lid can be guided to the container by (or along) the first and the second rail. In addition, the first rail can comprise the first support surface and the second rail can comprise the second support surface in such a way that the lid can be guided to the container via the first and the second rails. As an alternative, the guide surfaces of the rails can also run inclined as mentioned above.

The movement device can be arranged with an upwardly-directed carrier below the first and second rail or with a downwardly-directed carrier above the first and second rail. In these embodiments, the carrier can preferably be moved in a recess between the first and second rail. A recess can therefore be disposed between the first and second rail in such a way that the movement device (or carrier) can be moved through the recess to move the lid.

In addition, the first and/or second rail can be formed by a plurality of rail elements. As an alternative to the rails, the guide surfaces can also be the two lateral boundary surfaces of a groove disposed in a guide element.

In addition to the guide surfaces and, in particular, also the support surfaces, the feeding device can comprise a hold-down device. Here, the hold-down device is arranged at the lid guide in such a way that movability of the lid in a spatial direction can be restricted. Thus, if the lid is carried/supported (from below) by the guide surfaces or support surfaces, the hold-down device can restrict the movability of the lid upwards by arranging/moving the lid between the guide surfaces or support surfaces and the bold-down device.

In a preferred embodiment, the lid guide has the first rail with the first guide surface and the second rail with the second guide surface, and the hold-down device is arranged between the rails in such a way that movement of the lid in a single spatial direction (preferably upwards) can be/is restricted. In this context, the hold-down device can be regarded as a guide rail and, in particular, run parallel to the rails. Particularly preferably, the hold-down device is combined with rails that are open at the top in order to ensure increased hygiene through easier cleaning.

Particularly preferably, the lid guide can further comprise a gassing device. This gassing device can be arranged at a side (facing the sealing device) of the first and/or second rail The container is gassed by the gassing device before the lid is placed on the container. The gassing can be achieved with a gas like carbon dioxide or nitrogen.

While the first and second rail are preferably designed in such a way that the lid is guided radially and thus preferably moves co-radially to the movement device, the gassing device can be designed in such a way that the lid is guided linearly in a gassing area of the gassing device. This has the advantage that the gassing values can be improved and the transfer to the container can be optimized.

Thus, the gassing is preferably carried out by the gassing device stationarily arranged at the (stationary) rails. The gassing no longer must be carried out by a gassing rotor/the movement device.

In particular, the lid no longer has to be placed on the gassing rotor but can rest on the lid guide until it is brought together with the container. This bas the advantage that the interfering contours from the gassing rotor during the rising of the container are eliminated. Thus, cost-saving and more hygienic movement devices (such as lid rotors) can be designed.

The first and second rail are preferably designed with the guide and/or support surfaces such that they are open at the top. In this way, a cleaning medium can clean the lid support (i.e., the guide and/or support surfaces) without hindrance.

In addition, a sealer with a feeding device according to the disclosure is proposed. Here, the sealer further comprises a carousel having a plurality of sealing devices, a container feeder for the containers, in particular containers filled with a product, to the carousel and an outlet for sealed containers (with the lid) from the carousel.

Preferably, the feeding device according to the disclosure guides the lids from a de-stacking device until they are transferred to the container. After a de-stacking process, in which the lids are separated individually from the stack by the de-stacking device, the lid lies on the lid guide between the guide surfaces. The feeding device can be arranged in a working space of the sealer below the de-stacking device.

According to the disclosure, a method for sealing the container with the lid is further proposed. In the method according to the disclosure, the feeding device according to the disclosure is provided and the lid is transported to the container by the feeding device. Subsequently, the lid is placed on an opening of the container and the container is sealed with the lid.

The sealing of the container can comprise positioning the container on a lifting station, seaming the lid to the container by at least one seaming roller, in particular two seaming rollers, and the seaming head. Finally, the sealed container can be discharged from the working space of the sealer.

The working space is that space of the sealer in which the container is preferably sealed with the lid, in particular the space in which a seaming process takes place. Preferably, the working space is surrounded by a housing and thus delimits the working space of the sealer (and thus enables the formation of a hygiene zone).

In particular, the housing can be considered as a cladding, enclosure, casing, or sheath which at least partially surrounds the working space. The housing can close off and/or shield the working space from the outside, so that an atmosphere in the working space is hygienically separated from the environment.

The sealing device can comprise a sealing head for sealing the container with the lid. The sealing head can comprise a seaming means (or device) for seaming the lid to the container. The seaming means can be a seaming roller and a seaming head. The, or each sealing head can therefore comprise at least one seaming roller (particularly preferably two seaming rollers) and one seaming head. The sealing head can comprise seaming shafts rotatable about a seaming axis, wherein the seaming means is arranged at one end of the respective seaming shaft (seaming head and seaming roller can therefore be rotated in particular via respective seaming shafts).

The sealer according to the disclosure can further comprise the lifting station (or a plurality of lifting stations) for lifting the container. The lifting stations can be arranged opposite the sealing heads.

In practice, the sealer can comprise a container feeder for feeding the containers (such as an infeed table) to the working space and a container discharge for discharging the containers from the working space. A separating wall or blind can be arranged between the container feeder and the container discharge, which prevents a cross-contamination between the incoming and outgoing containers.

The sealer according to the disclosure is preferably designed as a can sealer. The can sealer usually has several similar stations (of preferably sealing heads and lifting stations) arranged in a carousel shape, in which a can is sealed in each case with a can lid.

Here, the container can be a can and the lid can be a can lid, which are seamed together by the can sealer.

For sealing the can, the can sealer preferably comprises several sealing heads (as described above with several seaming rollers and one seaming head). In the operating state, the seaming rollers with their respective seaming profiles are brought into contact with a can lid flange of the can lid and a can flange of the can. By rotating the can, the seaming roll is then rotated in the circumferential direction of the can, thereby seaming the can flange with the can lid flange. For rotation of the can, the can is preferably clamped between the seaming head and a support (in particular the lifting station), whereby the seaming head is rotated about the seaming axis by the seaming shaft.

In practice, as in the state of the art, the can sealer preferably comprises a clamping device made up of a seaming head and a lifting station, with which the can is fixed in the axial and radial direction for sealing and can be rotated in the circumferential direction.

In the context of the disclosure, the can can be understood to be a rotationally symmetrical container which is sealed by the can sealer and the associated seaming roller. A can can preferably comprise a metal, in particular aluminum or steel.

In principle, the sealer can preferably comprise at least two types of seaming rollers with preferably different seaming profiles (wherein the corresponding sealing head comprises seaming rolls of both types), so that cans can be sealed according to a double-seam principle, in which the cans are generally sealed in two steps. Here, one type of seaming roller is responsible for one step. The first type of seaming roller makes a pre-seam, while the second type of seaming roller completely seals the can/the package.

In the method according to the disclosure, can lids and can bodies can be brought together at a defined point before the actual seaming process. The feeding of the can lids is carried out by the feeding device according to the disclosure, on which the can lids rest. The can bodies are fed by the container feeder. The can bodies pass from the container feeder to one of the respective lifting stations (which are integrated in the carousel). On one revolution of the carousel, the lifting stations preferably perform a curve-controlled lifting movement to feed the cans from below to the can lid and later to the seaming head.

After a certain lifting distance, the can body thus comes into contact with the can lid.

Preferably the can sealer still comprises an ejection element. The ejection element is, for example, attached to an ejection rod, which performs a linear movement along the axial direction within a seaming shaft (the seaming head is attached to this seaming shaft). Preferably curve-controlled, the can lid is first clamped in the lid guide during the downward movement. As soon as the can body is driven in the can lid, the ejection element changes the direction of the lift and moves upward evenly with the lifting station. The supporting function of the ejection element ends when the can body and can lid are introduced into the seaming head. From this moment, the can is clamped between the lifting station and the seaming head. Subsequently, the actual seaming process is executed.

In principle, the sealer according to the disclosure can be analogous to the can sealers already known from the state of the art but differs in the feeding device, to avoid the disadvantages of the state of the art in this way.

### BRIEF DESCRIPTION OF THE DRAWINGS

In the following, the disclosure and the state of the art are explained in more detail based on embodiments with reference to the drawings.

FIG. 1 illustrates a plan view of a can sealer of the state of the art;

FIG. 2 illustrates a gassing rotor of the state of the art;

FIG. 3 illustrates a plan view of a can sealer according to the disclosure;

FIG. 4A illustrates a plan view of a feeding device according to the disclosure;

FIG. 4B illustrates a perspective view of a feeding device according to the disclosure;

FIG. 5 illustrates a side view of a feeding device according to the disclosure.

### DETAILED DESCRIPTION

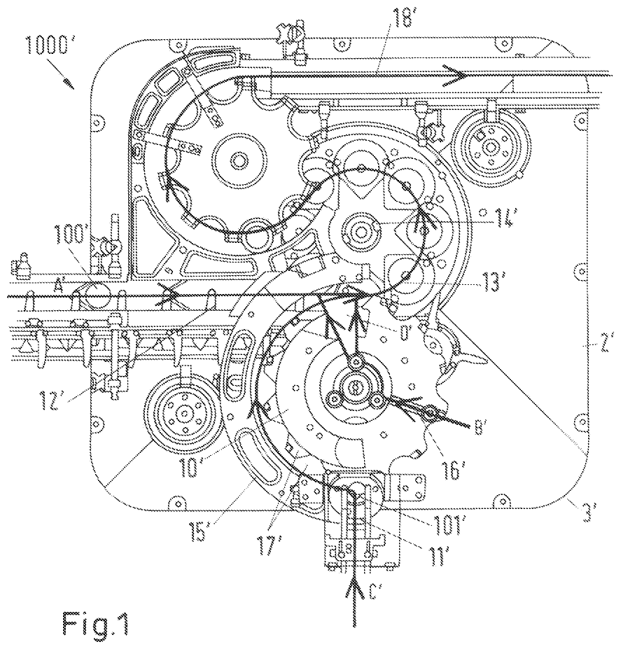

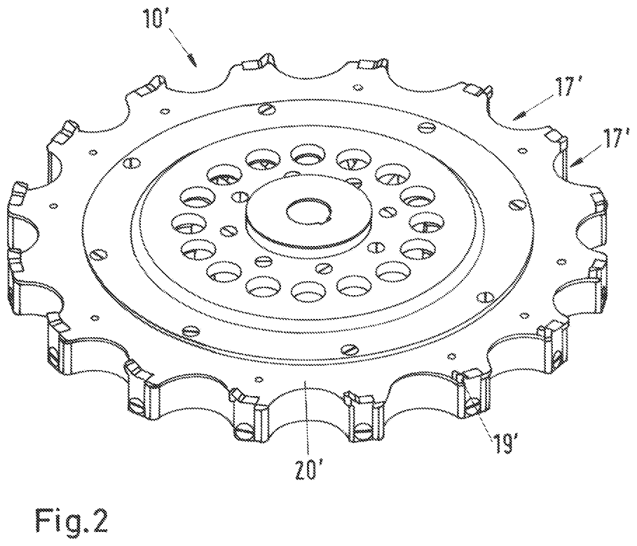

FIG. 1 and FIG. 2 have already been described above in the representation of the state of the art.

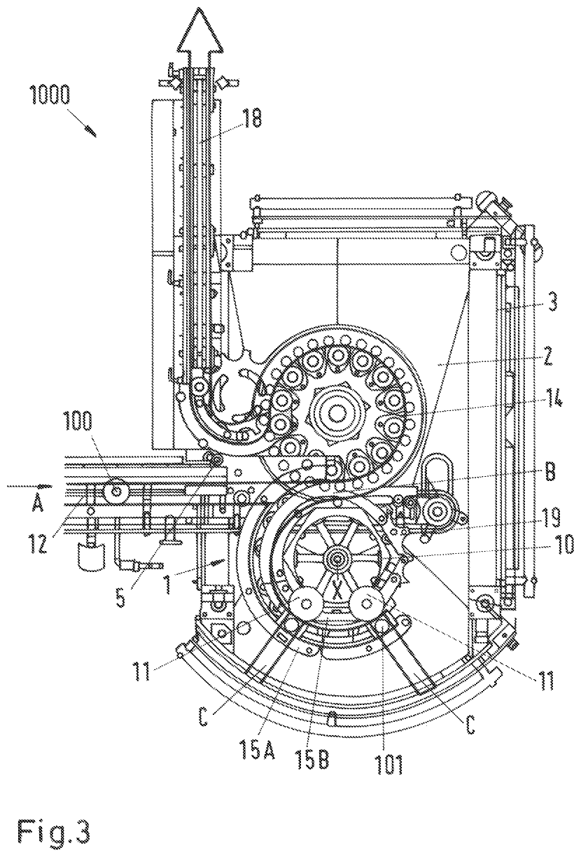

FIG. 3 shows a plan view of a can sealer 1000 according to the disclosure. In principle, the sealing process is performed in the analogous way to the state of the art, i.e., in the analogous way as described in FIGS. 1 and 2.

The can sealer 1000 according to FIG. 3 comprises two lid providing devices 11 for providing a lid 101 to a feeding device I according to the disclosure, which transports the lids 101 to the can 100.

The feeding device 1 comprises a movement device 10, which is arranged in a moveable manner in such a way that the lid 101 can be moved to the can 100 by the movement device 10. For this purpose, the movement device 10 is attached to a shaft and arranged in a rotatable manner about an axis X by this shaft, so that the lid 101 can be moved by a rotation of the movement device 10.

In addition, the feeding device 1 comprises a lid guide 15A, 15B arranged at the movement device 10 for guiding the lid 101 to the can 100. For this purpose, the lid guide 15A, 15B has a first rail 15A and a second rail 15B running parallel to the first rail, wherein the lid 101 is arranged between the rails 15A, 15B in such a way that the lid 101 is guided by the movement of the carrier 19 between the rails 15A, 15B to point B, where the lid 101 is united with the can 100 entering along A.

The carriers 19 arranged at the movement device 10 are distributed and arranged on a surface of the movement device 10 in such a way that they can set the lids 101 arranged on the lid guide 15A, 15B in motion.

In addition, the sealer 1000 comprises a seaming process/carousel having seaming stations 14 for sealing the can 100 with the lid 101. The seaming process 14 is arranged in a working space 2 of the can sealer 1000 surrounded by a housing 3.

The lid 101 is introduced by the lid providing device 11 into the working space 2 of the can sealer 1000 along the arrow C and guided to the can 100 by the lid guide.

In doing so, the lids 101 are deposited on the rails 15A, 15B. The lids 101 are transported further by rotation of the movement device.

Then, the cans 100 with lids 101 are guided further to the seaming process 14 and sealed there.

The cans 100 with lids 101 are clamped and sealed by the seaming process 14. The sealed can is conveyed by a further rotor into a can outlet 18.

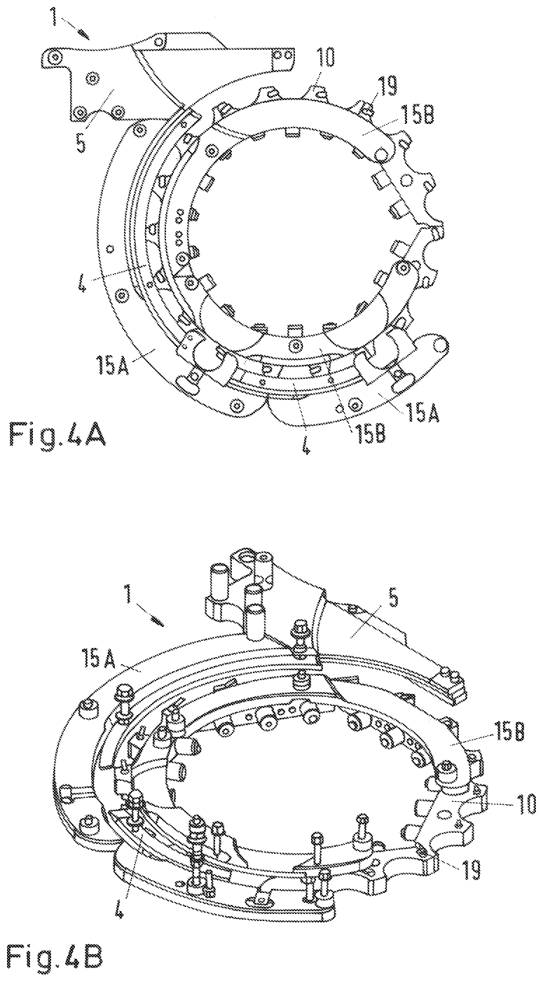

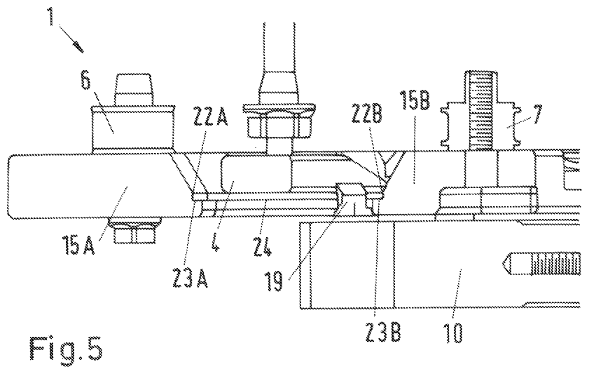

FIG. 4A shows a plan view of the feeding device 1 according to the disclosure, FIG. 4B shows a perspective view of the feeding device 1 according to the disclosure and FIG. 5 shows a side view of the feeding device I according to the disclosure.

The movement device 10 is designed in a star-shaped manner, wherein a carrier 19 is attached to each star tip for receiving and moving a lid.

The lid guides 15A, 15B comprises the first rail 15A and the second rail 15B, which runs parallel to the first rail 15A in sections. For this purpose, the first rail 15A is semi-annular and the second rail 15B is annular and arranged above the movement device 10.

Here, the first rail 15A comprises the first guide surface 22A the second rail 15B comprises the second guide surface 22B in such a way that the lid can be guided to the container by the first and the second rails 15A, 15B.

In addition, the first rail 15A comprises the first support surface 23A and the second rail 15B comprises the second support surface 23B in such a way that the lid can be guided to the container via the first and the second rails 15A, 15B, i.e., deposited on the support surfaces 23A, 23B and moved to the container via them.

The movement device 10 is arranged with upwardly-directed carriers 19 under the first and second rails 15A, 15B. Here, the carriers 19 can be moved in a recess 24 between the first and the second rails 15A, 15B.

In addition, the first and second rails 15A, 15B are formed by a plurality of rail elements.

The first and the second rails 15A, 15B are designed with the guide surfaces and support surfaces 22A, 22B, 23A, 23B such that they are open at the top. In this way, a cleaning medium can clean the lid support (i.e., the guide and/or support surfaces) without hindrance.

Furthermore, the lid guides 15A, 15B comprises a gassing device 5. This gassing device 5 is arranged on a side of the first rail 15A facing the seaming process 14.

While the first and the second rails 15A, 15B are shaped in such a way that the lid 101 is guided radially and thus preferably moves co-radially to the movement device 10, the gassing device 5 is shaped in such a way that the lid 101 is guided linearly in a gassing area of the gassing device 5. This has the advantage that the gassing values can be improved and the transfer to the container can be optimized.

During gassing by the gassing device 5, a gas such as an inert gas is conveyed to an underside of the lid 101. In this way, it can be ensured that a residual volume of the container 100 in which no foodstuff is arranged is substantially filled with the gas before sealing, whereby the air originally present in the residual volume is displaced as completely as possible by the gas. In this way, it can be possible to achieve a longer shelf life for the foodstuff arranged in the container 100.

However, before the lids are placed on the lid guides 15A, 15B, a de-stacking process takes place, in which the lids 101 are separated from the stack individually. Then, the lid 101 rests between lateral lid guides, i.e., the rails 15A, 15B, as described above. Then, the lid 101 is transported further to a defined point (point B) by the movement device 10, which is shaped as a lid star 10, with the aid of the radially attached lid carriers 19 between the lateral lid guides 15A, 15B. The lateral lid guides 15A, 15B together form the lid travel path.

Here, the rail 15B is an inner lid guide 15B. The first and second rail 15A, 15B are each formed by a plurality of rail elements. The rail element of the second rail 15B, which is located directly under the de-stacking device, does not have to be replaced in the case of a format change. In this way, changeover times and downtimes are reduced.

The lid 101 is guided from the de-stacking device to the point B completely resting between the rails 15A, 15B, and is not deposited on the lid star 10.

In addition, a hold-down device 4 is arranged above the rails 15A, 15B in such a way that a movability of the lid 101 upwards is restricted. In this way, the lid 101 is secured against falling out.

The rails 15A, 15B comprise a quick-change system 6, 7 in the form of quick-change spacer bolts 6 and 7. In this way, the rails 15A, 15B can be replaced with repeat accuracy. This saves having to readjust the format part after a tool change, which of course has a positive effect on tool change times.

The disclosure is not limited to the disclosed embodiments. Other variations of the disclosed embodiments can be understood and effected by persons skilled in the art in practicing a claimed disclosure from a study of the drawings, the disclosure, and the dependent claims. In the claims, the word “comprising” does not exclude other elements or steps, and the indefinite article “a” or “an” does not exclude a plurality. The mere fact that certain measures are repeated in mutually different dependent claims does not mean that a combination of these measures cannot be advantageously used. Any reference signs in the claims should not be interpreted as limiting the scope.

Particularly preferred embodiments of the disclosure comprise a combination of the rails with guide surfaces and support surfaces and the rotatably arranged movement device.

1. A feeding device for a sealer for guiding a lid to a container, comprising;
a movement device arranged in a movable manner in such a way that the lid is capable of being moved by the movement device; and
a lid guide arranged at the movement device and configured to guide the lid to the container,
the lid guide comprising a first guide surface and a second guide surface, the lid capable of being arranged between the first guide surface and the second guide surface in such a way that the lid is capable of being guided to the container by relative movement of the movement device to the first guide surface and the second guide surface.

2. The feeding device according to claim 1, wherein the lid guide is stationarily arranged in such a way that the lid is capable of being to the container by the movement of the movement device along the lid guide.

3. The feeding device according to claim 1, wherein the movement device comprises a carrier, the carrier is attached to the movement device in such a way that the lid is capable of being received by the carrier and moved by the carrier in the lid guide.

4. The feeding device according to claim 3, wherein the carrier is arranged in a movable manner between the first guide surface and the second guide surface.

5. The feeding device according to claim 3, wherein the carrier is one of a plurality of carriers of the movement device, so that a plurality of the lids is capable of being received by the plurality of carriers and moved by the lid guide.

6. The feeding device according to claim 5, wherein the plurality of carriers is arranged distributed along a circumference of the movement device.

7. The feeding device according to claim 6, wherein the plurality of carriers is arranged circularly along the circumference of the movement device.

8. The feeding device according to claim 1, wherein the movement device is arranged rotatably about an axis by a shaft, so that the lid is capable of being moved by a rotation of the movement device.

9. The feeding device according to claim 8, wherein the movement device has a shape of a disk and the shaft is arranged at a center point of the movement device.

10. The feeding device according to claim 1, wherein the lid guide comprises a first rail and a second rail running parallel to the first rail and the first rail comprises the first guide surface and the second rail comprises the second guide surface in such a way that the lid is capable of being guided to the container by the first and the second rails.

11. The feeding device according to claim 10, wherein the first or the second rail is formed by a plurality of rail elements.

12. The feeding device according to claim 10, wherein a recess is disposed between the first rail and the second rail in such a way that the movement device is capable of being moved through the recess for moving the lid.

13. The feeding device according to claim 1, further comprising a hold-down device arranged at the lid guide so as to be able to restrict movability of the lid a spatial direction.

14. The feeding device according to claim 1, wherein the lid guide comprises a first rail with the first guide surface and a second rail with the second guide surface, and the feeding device further comprises a hold-down device arranged between the first and second rails so as to be able to restrict movability of the lid in a spatial direction.

15. A sealer, comprising:
a carousel with a plurality of sealing devices;
a container feeder for feeding the container to the carousel;
a feeding device according to claim land configured to guide the lid to the container; and
an outlet for the container that has been sealed from the carousel.

16. A method for sealing a container with a lid, comprising:
providing a feeding device according to claim 1; and
transporting the lid to the container by the feeding device; and
placing the lid on an opening of the container; and
sealing the container with the lid.

17. The method according to claim 16, wherein the sealing of the container comprises
positioning the container on a lifting element; and
seaming the lid to the container by at least one seaming roller and a seaming head.

18. A sealer, comprising:
a carousel with a plurality of sealing devices;
a container feeder for feeding the container filled with a product to the carousel;
a feeding device according to claim land configured to guide the lid to the container; and
an outlet for the container that has been sealed from the carousel.
